(19) United States
(12) Patent Application Publication
(10) Pub. No.: US 2023/0185615 A1
(43) Pub. Date: Jun. 15, 2023

(54) AUTOMATED SCHEDULING OF SOFTWARE DEFINED DATA CENTER (SDDC) UPGRADES AT SCALE

(71) Applicant: VMware, Inc., Palo Alto, CA (US)

(72) Inventors: Vijayakumar KAMABATHULA, Leander, TX (US); Vaibhav KOHLI, Austin, TX (US)

(21) Appl. No.: 17/644,272

(22) Filed: Dec. 14, 2021

(51) Int. Cl. G06F 9/50

(52) U.S. Cl. CPC G06F 9/5027

(57) ABSTRACT

The disclosure provides an approach for resource-aware software-defined data center (SDDC) upgrades. Embodiments include identifying a plurality of upgrade phases for upgrading components of a plurality of computing devices across a plurality of SDDCs. Embodiments include identifying a plurality of time slots based on support resource availability information. Embodiments include determining one or more constraints related to the plurality of SDDCs, wherein the one or more constrains comprise at least one constraint related to physical computing resource utilization. Embodiments include receiving physical computing resource utilization information related to the plurality of computing devices. Embodiments include assigning the plurality of upgrade phases to particular time slots of the plurality of time slots based on the one or more constraints and the physical computing resource utilization information for the plurality of computing devices.

### BACKGROUND

A software-defined data center (SDDC) generally comprises a plurality of hosts in communication over a physical network infrastructure. For example, SDDCs may be provided via software as a service (SaaS) to a plurality of customers. Each host of an SDDC is a physical computer (machine) that may run one or more virtualized endpoints such as virtual machines (VMs), containers, and/or other virtual computing instances (VCIs). In some cases, VCIs are connected to software-defined networks (SDNs), sometimes referred to as logical overlay networks, that may span multiple hosts and are decoupled from the underlying physical network infrastructure.

Services related to SDDCs, such as virtual network infrastructure software, may need to undergo maintenance on occasion, such as being upgraded, patched, or otherwise modified. In some cases, such a maintenance action is referred to as a rollout. Providing rollouts to services that are running on multiple data centers (e.g., providing a service upgrade to a potentially large number of customers that utilize a given service on their data centers) is challenging for a variety of reasons. For example, a rollout schedule for SDDCs provided via SaaS to a plurality of customers may need to be generated based on various constraints such as customer maintenance preferences (e.g., date and time preferences expressed by customers), SDDC regional preferences (e.g., date and time preferences applicable to the region in which an SDDC is located), the availability of support resources such as support professionals to assist with activities related to the rollout, and/or the like. Preparing such a schedule is a complicated, tedious, time-consuming, and error-prone process, particularly for a rollout that involves a large number of SDDCs. Furthermore, even if all parties' preferences are taken into account, rollout activities may still interfere with normal operations on the SDDCs, such as if rollout activities utilize physical computing resources that are needed by other processes on the SDDCs at a particular time, if rollout activities fail and cause disruptions to workflows on an SDDC, if rollouts cause services to be unavailable at inopportune times, and/or the like.

Accordingly, there is a need in the art for improved techniques for performing maintenance operations across multiple SDDCs, particularly in cases where maintenance operations need to be performed across a large number of SDDCs (e.g., thousands).

### BRIEF DESCRIPTION OF THE DRAWINGS

FIG. 1 depicts example physical and virtual network components with which embodiments of the present disclosure may be implemented.

FIG. 2 illustrates an example related to automated resource-aware scheduling of software-defined data center (SDDC) upgrades.

FIG. 3 illustrates another example of automated resource-aware scheduling of software-defined data center (SDDC) upgrades.

FIG. 4 illustrates an example related to data intelligence for automated resource-aware scheduling of software-defined data center (SDDC) upgrades.

FIG. 5 depicts example operations related to automated resource-aware scheduling of software-defined data center (SDDC) upgrades.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The present disclosure provides an approach for automated resource-aware scheduling of upgrades across a plurality of software-defined data centers (SDDCs) According to certain embodiments, phases of an upgrade across multiple SDDCs are automatically assigned to time slots based on various constraints and/or resource availability information, including availability of physical computing resources and/or support resources.

An SDDC upgrade (e.g., involving an upgrade, patch, or other change to a service) may involve multiple phases to be performed on a plurality of SDDCs. In some cases, gaps may be needed between phases to avoid back-to-back maintenance operations on customer SDDCs. In one example, a workflow related to a rollout of an SDDC upgrade involves three phases on each given SDDC, including a first phase for upgrading installation files, a second phase for upgrading a control plane, and a third phase for upgrading hosts in the SDDC. A rollout generally comprises multiple waves and a plan to perform the upgrade on multiple SDDCs based on version, region, and/or the like. An upgrade manager, which may be a service running in a software-as-a-service (SaaS) layer, may orchestrate the rollout across the plurality of SDDCs. In one embodiments, the upgrade manager determines rollout waves by dividing the plurality of SDDCs (e.g., which are eligible for the upgrade) into groups based on various criteria (e.g., organization type, region, risk level, and the like), with each group being referred to as a wave. Waves may be upgraded in a sequential manner, such as by upgrading all SDDCs in the first wave before upgrading all SDDCs in the second wave.

Support resource capacity may then be determined, such as based on availability information for support professionals. For example, such information may be defined in a support plan that indicates days and times on which support professionals are available, how many support professionals are available at those times, and the like. According to certain embodiments, the support plan is used to determine how many SDDCs can be upgraded at a given time with adequate support resources being available. For example, each day may be divided into twenty-four windows of one hour each that may be referred to as support windows, and the number of SDDCs that can be upgraded during a given support window may be referred to as a support window capacity. A set of contiguous support windows that have at least one available seat may be referred to as a maintenance window, which may have a length of one or more hours. The size of a maintenance window may refer to the number of support windows it contains.

According to certain embodiments described herein, each upgrade phase of an SDDC is assigned to a particular maintenance window, and the upgrade phase takes up one “seat” from the support windows in the particular maintenance window, reducing the available capacity of those support windows by one. For example, a maintenance window for a given phase may include multiple support windows (e.g., of one hour each). A maintenance window defines a start time and estimated completion time of a given upgrade phase assigned to the maintenance window. Automatic assignment of upgrade phases to maintenance windows may referred to as auto-placement. Auto-placement may be based on a variety of constraints and/or factors, such as physical computing resource availability, customer preferences, geographic preferences, and/or the like.

In one example, customers specify preferences regarding days and/or times on which upgrades should be performed and/or not performed. For example, a customer may specify that for a particular SDDC or group of SDDCs upgrades should preferably be performed on Saturdays and/or Sundays and should preferably not be performed on Wednesdays (e.g., Wednesday may be when the customer typically sees the highest amount of activity on these SDDCs each week). In another example, a particular geographic region may be associated with certain preferences, such as holidays common to that region or time windows that are more commonly active or inactive for that region. A regional preference for the United States may specify, for example, that upgrades should preferably be scheduled on July 4^{th} due to the national Independence Day holiday (e.g., because the SDDCs in this region are likely to experience less activity on this day). In one example, regional preferences may relate to common business hours in a given region, such as indicating a preference that upgrades being performed during non-business hours.

Customer and/or regional preferences may also include particular scheduled events, such as planned outages and/or other types of activities that would likely affect the ability of an upgrade to be completed successfully. For instance, if a customer has a product release scheduled for a particular day, the customer may indicate a preference that upgrades should not be performed on that day or even for the entire week or month during which the product release is scheduled.

In some embodiments, support plans and/or preferences such as customer and/or regional preferences are defined in one or more objects, such as javascript object notation (JSON) files. These objects may be received by the upgrade manager, which may utilize the information in the objects when performing auto-placement of upgrade phases in maintenance windows. In some embodiments, support plans and/or preferences such as customer and/or regional preferences may be received via a user interface.

The upgrade manager may also receive data indicating physical computing resource availability on SDDCs. Physical computing resources may include, for example, processing resources, memory resources, network resources, and/or the like. In some embodiments, historical physical computing resource utilization data from an SDDC is used to predict future physical computing resource utilization. For example, a machine learning model may be trained based on the historical data to predict future physical computing resource utilization for a given SDDC, such as based on historical physical computing resource utilization data from the same SDDC or from similar SDDCs (e.g., SDDCs having similar configurations). The predicted future physical computing resource utilization may be used during auto-placement, such as to schedule upgrade phases for times when physical computing resource utilization is predicted to be low.

In some embodiments, the upgrade manager automatically generates a schedule for a rollout that satisfies all constraints as best as possible and maximizes available support and physical computing resources. A score may be generated for a rollout schedule, such as based on whether support resources are under-utilized and/or over-utilized by the rollout schedule. Scores may then be used to select the best rollout schedule. For instance, the upgrade manager may generate a plurality of rollout schedules (e.g., random permutations that satisfy all constraints as best as possible and maximize resource availability), and choose the rollout schedule with the highest score. In certain embodiments, candidate rollout schedules and corresponding scores may be displayed to a user via a user interface, and the user may select a rollout schedule from the options displayed.

In some cases, the user interface allows a user (e.g., an administrator) to manage the initiation and scheduling of rollouts, such as by allowing the user to specify constraints and/or preferences, and presenting the user with candidate rollout schedules generated through auto-placement (e.g., along with scores) and allowing the user to provide input confirming, denying, and/or changing the candidate rollout schedules.

Furthermore, in some embodiments, upgrade phases may be dynamically rescheduled as needed, such as based on detecting outages at specific SDDC regions. For example, if the upgrade manager determines that an outage is occurring with respect to a given SDDC, the upgrade manager may reschedule any scheduled upgrade phases for that SDDC that fall within a certain time window of the detected outage to a time outside of the time window.

In certain embodiments, durations of upgrade phases may be estimated based on past durations of upgrade phases, such as those with the same or similar attributes to the upgrade phases for which the durations are being estimated. For example, an average duration of all past similar upgrade phases for which historical data is available may be used as the estimated duration of a given upgrade phase. In some cases, machine learning may be used to estimate upgrade phase durations, such as by training a machine learning model based on past upgrade phase durations. Estimated upgrade phase durations may be used when assigning upgrade phases to maintenance windows, such as by assigning a given upgrade phase to a maintenance window of a size sufficient to support the estimated duration of the given upgrade phase (e.g., including a sufficient number of support windows, which may be one hour each, for the estimated duration of the given upgrade phase).

Embodiments of the present disclosure provide various improvements over conventional techniques for scheduling upgrades on multiple SDDCs. For example, techniques described herein for automated resource-aware scheduling of SDDC upgrades avoid the time-consuming and error-prone process of manual schedule determination (e.g., through an autoamted process that is scalable across a potentially large number of SDDCs) and provide for more dynamic upgrade scheduling through the use of particular constraints and resource availability information. By scheduling upgrade operations on SDDCs for times at which support resources are available and taking into account various constraints such as days and times at which SDDCs are expected to be particularly busy or downtime is most likely to be disruptive to ongoing processing, embodiments of the present disclosure improve the functioning of the computer systems involved by ensuring that upgrades are completed in a timely, orderly, and non-disruptive fashion. Certain embodiments involve the use of predicted physical computing resource utilization for SDDCs to optimize upgrade scheduling, such as by scheduling upgrade operations for times at which physical computing resource utilization is predicted to be otherwise low, thereby avoiding overutilization of physical computing resources, improving the functioning of computer systems in SDDCs, and reducing the business impact of upgrades to customers. Furthermore, the use of data intelligence such as for predicting durations of upgrade phases based on historical upgrade phase durations allows for more accurate estimations of completion times for upgrade phases, thereby allowing the resource-aware automated scheduling of upgrade phases to be more accurate and effective. Additionally, dynamic automated rescheduling of upgrade phases based on detected outages as described herein allows for a more resilient upgrade process in which real-time conditions are taken into account and adapted to.

Scoring of automatically-generated upgrade schedules based on resource underutilization and overutilization allows for the selection of an optimal upgrade schedule from multiple options, thereby resulting in an improved automate schedule and, consequently, better functioning of the computer systems on which the upgrades are performed (e.g., due to better utilization of support and physical computing resources, upgrades that run more smoothly and complete sooner due to the availability of support resources, and the like). Furthermore, providing a user interface that allows for the management of SDDC upgrades as described herein provides improved orchestration of upgrades that span multiple SDDCs, allowing users to review and provide input related to the automated scheduling processes described herein.

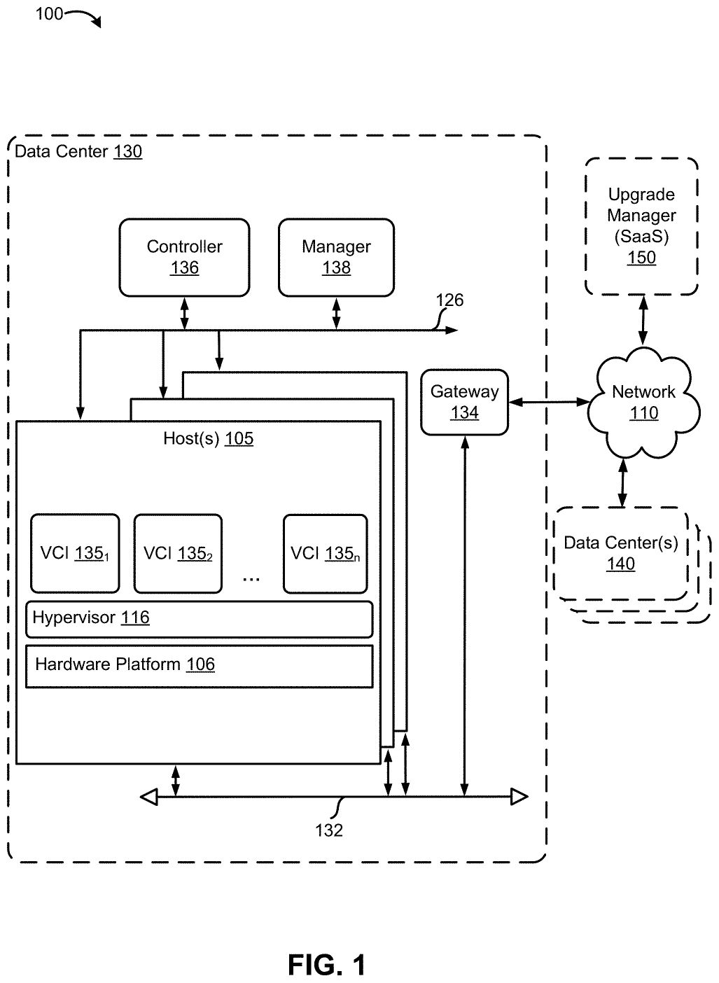

FIG. 1 depicts example physical and virtual network components with which embodiments of the present disclosure may be implemented.

Networking environment 100 includes data center 130 connected to network 110. Network 110 is generally representative of a network of machines such as a local area network (“LAN”) or a wide area network (“WAN”), a network of networks, such as the Internet, or any connection over which data may be transmitted.

Data center 130 generally represents a set of networked machines and may comprise a logical overlay network. Data center 130 includes host(s) 105, a gateway 134, a data network 132, which may be a Layer 3 network, and a management network 126. Host(s) 105 may be an example of machines. Data network 132 and management network 126 may be separate physical networks or different virtual local area networks (VLANs) on the same physical network.

One or more additional data centers 140 are connected to data center 130 via network 110, and may include components similar to those shown and described with respect to data center 130. Communication between the different data centers may be performed via gateways associated with the different data centers.

Each of hosts 105 may include a server grade hardware platform 106, such as an x86 architecture platform. For example, hosts 105 may be geographically co-located servers on the same rack or on different racks. Host 105 is configured to provide a virtualization layer, also referred to as a hypervisor 116, that abstracts processor, memory, storage, and networking resources of hardware platform 106 for multiple virtual computing instances (VCIs) 135i to 135n (collectively referred to as VCIs 135 and individually referred to as VCI 135) that run concurrently on the same host. VCIs 135 may include, for instance, VMs, containers, virtual appliances, and/or the like. VCIs 135 may be an example of machines. For example, a containerized microservice may run on a VCI 135.

In certain aspects, hypervisor 116 may run in conjunction with an operating system (not shown) in host 105. In some embodiments, hypervisor 116 can be installed as system level software directly on hardware platform 106 of host 105 (often referred to as “bare metal” installation) and be conceptually interposed between the physical hardware and the guest operating systems executing in the virtual machines. It is noted that the term “operating system,” as used herein, may refer to a hypervisor. In certain aspects, hypervisor 116 implements one or more logical entities, such as logical switches, routers, etc. as one or more virtual entities such as virtual switches, routers, etc. In some implementations, hypervisor 116 may comprise system level software as well as a “Domain 0” or “Root Partition” virtual machine (not shown) which is a privileged machine that has access to the physical hardware resources of the host. In this implementation, one or more of a virtual switch, virtual router, virtual tunnel endpoint (VTEP), etc., along with hardware drivers, may reside in the privileged virtual machine.

Gateway 134 provides VCIs 135 and other components in data center 130 with connectivity to network 110, and is used to communicate with destinations external to data center 130 (not shown). Gateway 134 may be implemented as one or more VCIs, physical devices, and/or software modules running within one or more hosts 105.

Controller 136 generally represents a control plane that manages configuration of VCIs 135 within data center 130. Controller 136 may be a computer program that resides and executes in a central server in data center 130 or, alternatively, controller 136 may run as a virtual appliance (e.g., a VM) in one of hosts 105. Although shown as a single unit, it should be understood that controller 136 may be implemented as a distributed or clustered system. That is, controller 136 may include multiple servers or virtual computing instances that implement controller functions. Controller 136 is associated with one or more virtual and/or physical CPUs (not shown). Processor(s) resources allotted or assigned to controller 136 may be unique to controller 136, or may be shared with other components of data center 130. Controller 136 communicates with hosts 105 via management network 126.

Manager 138 represents a management plane comprising one or more computing devices responsible for receiving logical network configuration inputs, such as from a network administrator, defining one or more endpoints (e.g., VCIs and/or containers) and the connections between the endpoints, as well as rules governing communications between various endpoints. In one embodiment, manager 138 is a computer program that executes in a central server in networking environment 100, or alternatively, manager 138 may run in a VM, e.g. in one of hosts 105. Manager 138 is configured to receive inputs from an administrator or other entity, e.g., via a web interface or API, and carry out administrative tasks for data center 130, including centralized network management and providing an aggregated system view for a user.

According to embodiments of the present disclosure, one or more components of data center 130 may be upgraded, patched, or otherwise modified as part of a rollout that spans multiple data centers, such as data center 130 and one or more data centers 140. For example, an upgrade to virtualization infrastructure software may involve upgrading manager 138, controller 136, hypervisor 116, and/or one or more additional components of data center 130.

Upgrade manager 150 generally represents a service that manages upgrades across multiple data centers. For example upgrade manager 150 may perform operations described herein for automated resource-aware scheduling of SDDC upgrades. In some embodiments, upgrade manager 150 is a service that runs in a software as a service (SaaS) layer, which may be run on one or more computing devices outside of data center 130 and/or data center(s) 140, such as a server computer, and/or on or more hosts in data center 130 and/or data center(s) 140.

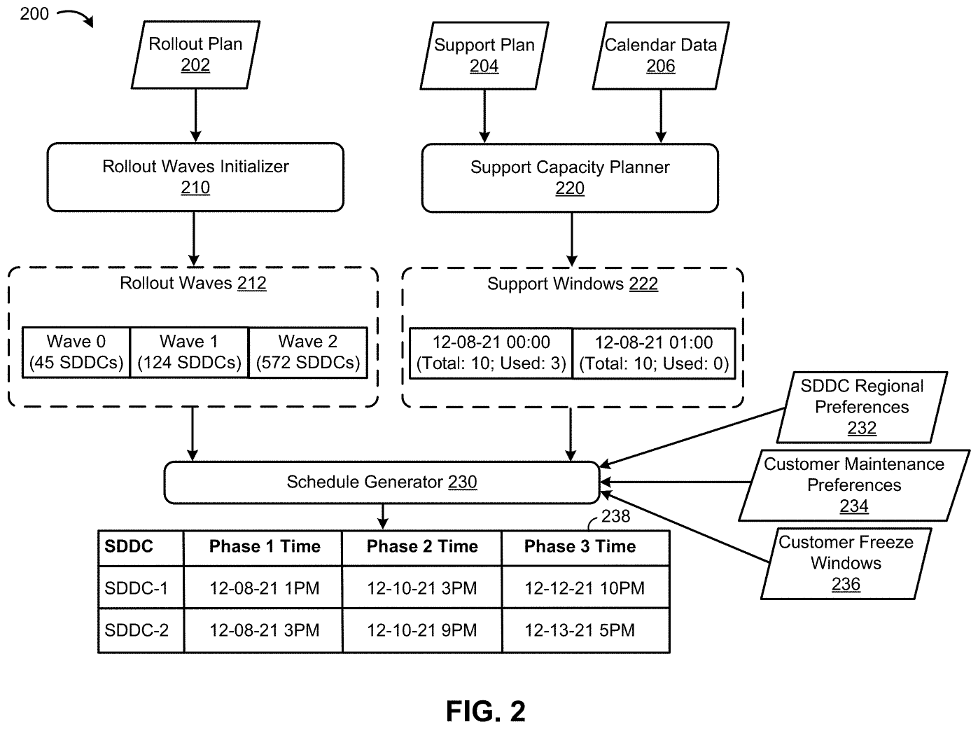

As described in more detail below with respect to FIG. 2, upgrade manager 150 may comprise a schedule generator that automatically generates a schedule for performing upgrade phases on multiple SDDCs. In some embodiments, upgrade manager 150 provides a user interface by which users can manage SDDC upgrades, such as providing constraints and preferences as well as reviewing and providing feedback with respect to automatically generated upgrade schedules.

FIG. 2 is an illustration 200 of an example related to automated resource-aware scheduling of software-defined data center (SDDC) upgrades. Illustration 200 includes rollout waves initializer 210, support capacity planner 220, and schedule generator 230, which may be components of upgrade manager 150 of FIG. 1.

A rollout plan 202 is received by rollout waves initializer 210. According to certain embodiments, rollout plan 202 is an object (e.g., a JSON object) or other type of document that defines waves of a rollout, with each wave including a group of one or more SDDCs that meet one or more criteria. In certain embodiments, the criteria may be defined by one or more users via a user interface. In one example, rollout plan 202 indicates that a first wave includes all internal customer SDDCs with more than 2 hosts, a second wave includes 40% of customer SDDCs with between 3 and 6 hosts, and a third wave includes all remaining customer SDDCs with 6 or more hosts. Rollout waves initializer generates rollout waves 212 based on rollout plan 202. Rollout waves 212 include a first wave (wave 0) with 45 SDDCs, a second wave (wave 1) with 124 SDDCs, and a third wave (wave 2) with 472 SDDCs.

Support plan 204 and country-specific calendar data 206 are received by support capacity planner 220, which performs operations related to determining support windows as described herein. Support plan 204 may, for example, be an object (e.g., a JSON object) or other type of document that defines time slots during which support resources are available, such as support professionals capable of assisting with issues that may arise during rollouts. For each time slot, support plan 204 defines a capacity, which indicates a number of concurrent upgrades that can be supported by the available support resources. Country-specific calendar data 206 generally includes information about holidays and other days on which support resources are expected to be unavailable (e.g., regardless of whether such unavailability is indicated in support plan 204), which may be specific to particular countries or other regions. Thus, support capacity planner 220 may factor in the unavailable days indicated in country-specific calendar data 206 when determining support windows 222.

Support capacity planner 220 uses support plan 204 and/or country-specific calendar data 206 to determine support windows 222. For instance, each day may be divided into twenty-four support windows of one hour each, and the number of SDDCs that can be upgraded during a given support window is the capacity of that support window. There are two example support windows depicted in support windows 222, including a first support window on Dec. 8, 2021 at 00:00 and a second support window on Dec. 8, 2021 at 01:00. The first support window has a capacity of 10, and 3 “seats” of this capacity are used. The second support window has a capacity of 10, and no seats of this capacity are used. A maintenance window may be a set of contiguous support windows that have at least one available seat, and the size of a maintenance window may be the number of support windows it contains. For example, a maintenance window may include both the first support window and the second support window in support windows 222.

Schedule generator 230 receives rollout waves 212 and support windows 222. Furthermore, schedule generator 230 receives SDDC regional preferences 232, customer maintenance preferences 234, and customer freeze windows 236.

SDDC regional preferences 232 generally include preferences associated with geographic regions in which SDDCs are located, and may include information such as holidays and other days on which downtime is expected in particular regions. Customer maintenance preferences 234 generally includes preferences specific to particular customers, and are applicable to the SDDCs associated with those customers. For example, customer maintenance preferences 234 may include indications of days and/or times at which certain customers prefer maintenance operations to be scheduled. Customer freeze windows 236 may indicate time windows during which operations will be frozen on SDDCs of customers, such as for other hardware or software maintenance operations, and during which no upgrades should be scheduled. In alternative embodiments, customer freeze windows 236 are part of customer maintenance preferences 234.

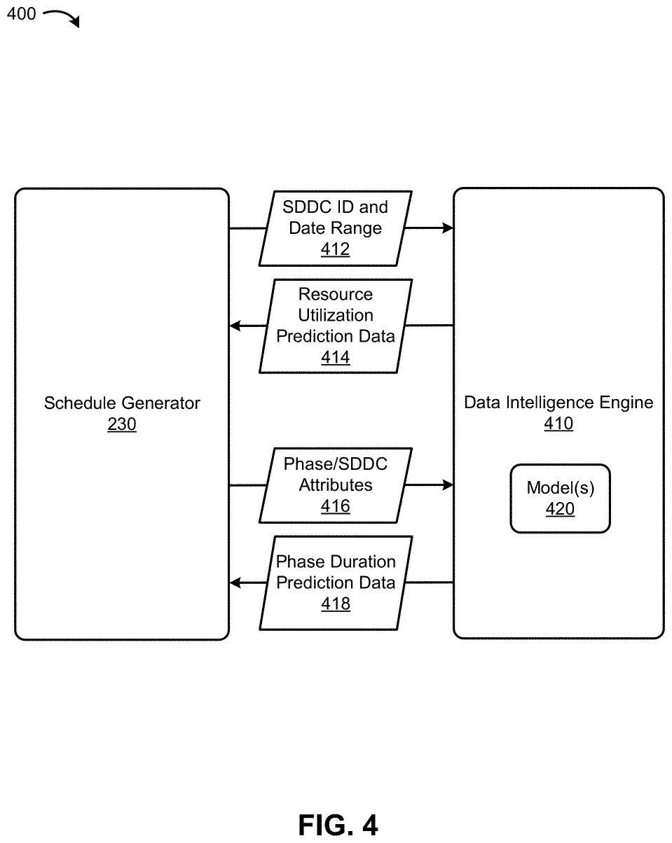

Schedule generator 230 generates a schedule 238 based on rollout waves 212, support windows 222, SDDC regional preferences 232, customer maintenance preferences 234, and/or customer freeze windows 236. Schedule 238 includes assignments of three phases of upgrades to two different SDDCs (SDDC-1 and SDDC-2) that are part of rollout waves 212 to particular maintenance windows that include one or more support windows 222 based on constraints and/or preferences, such as SDDC regional preferences 232, customer maintenance preferences 234, and/or customer freeze windows 236. As described in more detail below with respect to FIG. 4, schedule generator 230 may also receive information related to physical computing resource availability on SDDCs, and may utilize this information when generating schedule 238. Schedule generator 230 produces an optimal placement of SDDC upgrade phases into the support windows such that all the constraints are satisfied. At the same time, schedule generator 230 produces a schedule that efficiently utilizes support resources to complete the entire rollout as soon as possible, such as through the use of scores that indicate an extent to which an automatically-generated scheduled over-utilizes and/or under-utilizes support resources.

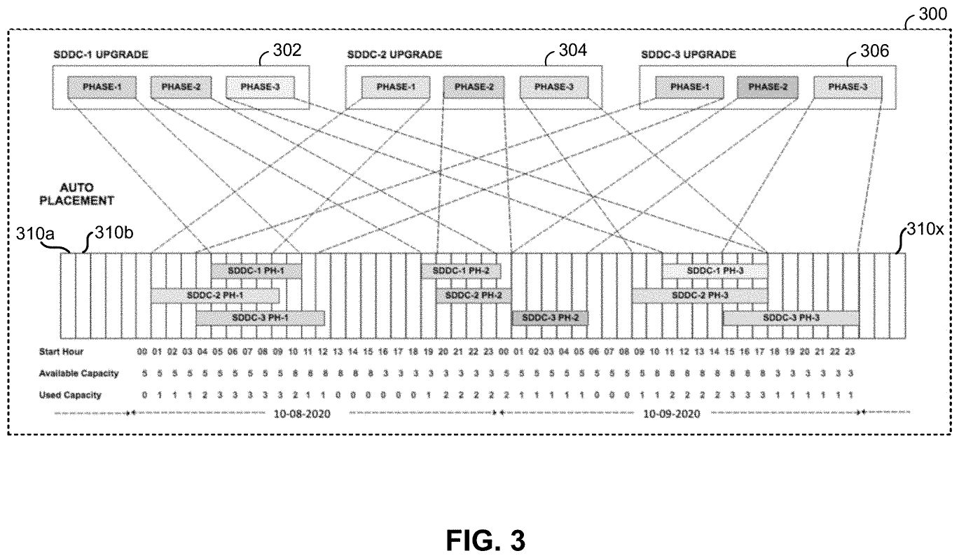

In schedule 238, for SDDC-1, Phase 1 of the upgrade is scheduled for Dec. 8, 2021 at 12 AM, Phase 2 of the upgrade is scheduled for Dec. 10, 2021 at 3 PM, and Phase 3 of the upgrade is scheduled for Dec. 12, 2021 at 10 PM. For SDDC-2, Phase 1 of the upgrade is scheduled for Dec. 8, 2021 at 1 AM, Phase 2 of the upgrade is scheduled for Dec. 10, 2021 at 9 PM, and Phase 3 of the upgrade is scheduled for Dec. 13, 2021 at 5 PM. Assignment of upgrade phases to maintenance windows, or auto-placement, is described in more detail below with respect to FIG. 3.

FIG. 3 depicts an illustration 300 of another example of automated resource-aware scheduling of SDDC upgrades. In particular, illustration 300 shows the assignment of phases of SDDC upgrades 302, 304, and 306 to maintenance windows that include support windows 310a-x (collectively, support windows 310). Each SDDC upgrade 302, 304, and 306 includes three phases, and each of support windows 310 is a one hour time window with an available capacity that indicates how many SDDCs can be concurrently upgraded during the support window. The used capacity of each support window 310 indicates how many SDDC upgrade phases are currently scheduled for that support window.

For example, phase-2 of SDDC-1 upgrade 302 is placed into 5 support windows 310 from 10-08-2020 19:00 to 10-09-2020 01:00, which together form a maintenance window. Furthermore, the support window 310 at 10-08-2020 08:00 has 5 seats available and 3 seats are consumed by the auto-placement, whereas the support window 310 at 10-08-2020 16:00 has 3 seats available, and none of these seats are consumed by SDDCs.

An estimated completion duration (in hours) of an SDDC upgrade phase determines the size of a maintenance window required for placement of the phase. In some embodiments fixed values are used to determine estimated completion durations of upgrade phases, while in other embodiments, such as described below with respect to FIG. 4, machine learning techniques may be used to determine estimated completion durations. A maintenance window is represented by a set of contiguous support windows which have available capacity. The size of a maintenance window is the number of support windows it contains. For the auto-placement shown in illustration 300, Phase-1 of SDDC-1 upgrade 302 is estimated to take 6 hours to complete, so it can be placed into any one of the 43 maintenance windows (there are 43 maintenance windows of size 6 from the 2 days shown in illustration 300). Similarly, phase-1 of both of the SDDC-2 and SDDC-3 upgrades 304 and 306 have 40 possible maintenance window placements (each of these upgrade phases is estimated to take 9 hours, and there are 40 maintenance windows of size 9).

In this example, there are 68,800 (43*40*40) possible solutions for placing the phase-1 upgrades of the 3 SDDCs. This solution space becomes much larger considering possible placements including the other 2 phases. The auto-placement algorithm reduces the total possible solutions by filtering out all maintenance windows that violate placement constraints. Furthermore, the algorithm gives a score to each possible solution, called an auto-placement score, which is based on under-utilization and/or over-utilization of support windows. The algorithm explores different possible solutions using a local search optimization technique, for example generating an optimal solution which has the best auto-placement score. For example, the algorithm may involve starting with placing each phase in the first available maintenance window that will support that phase (or with a randomly-generated placement), calculating an auto-placement score for that placement, and then varying the placements and generating corresponding auto-placement scores for those placements. In some embodiments, if an auto-placement score for a particular placement falls below or exceeds a threshold, the algorithm stops and that placement is selected. In other embodiments, a number of placements are generated and the placement with the lowest or highest auto-placement score is selected.

Auto-placement scores are generally used by the algorithm to compare two possible placements. In some embodiments, a placement with a smaller score is better, as it represents a smaller amount of over-utilization and/or under-utilization of support resources. For example, an auto placement score may be defined by a support over-utilization score and a support under-utilization score as follows: auto_placement score=(support_over_utlization_score, support_under_utilization_score). For example, support_over_utlization_score may be equal to the number of support window seats consumed beyond the available seats across all the given support windows. For example, if a support window has 3 seats available but the algorithm places 5 SDDCs into the support window, then the support_over_utlization_score of the support window is 2. The support_over_utilization_score of a solution (e.g., a placement or schedule) is the sum of the over utilization scores of all the given support windows.

Similarly, support_under_utilization_score may be defined as the number of unused support window seats across all the given support windows. For example, if a support window has 10 seats available but the algorithm places 5 SDDCs into it, then the support_under_utilization_score of the support window is 5. The support_under_utilization_score of a solution is the sum of the under-utilization scores of all the given support windows.

In some embodiments, the algorithm first uses support_over_utlization_score to compare two solutions. For example, if one of the solutions has a lower support_over_utlization_score, then that solution may be selected regardless of the support_under_utilization_score. If two solutions have the same support_over_utlization_score, then support_under_utilization_score may be used to compare the two solutions. In some embodiments, the best solution is the one with the smallest support_under_utilization_score. In other embodiments, both support_over_utilization_score and support_under_utilization_score are compared every time.

In some embodiments, one or more automatically generated schedules are displayed via a user interface along with auto-placement scores (e.g., the schedules may be ordered based on auto-placement score), and a user may select a schedule from those displayed or indicate that additional candidate schedules should be generated (e.g., if the user does not like any of the options presented). For example, if the user indicates that additional candidate schedules should be generated, then the auto-placement algorithm may be re-run one or more times to generate the additional candidate schedules.

Constraints may relate to days and/or times for which upgrade phases should or should not be scheduled, physical computing resource availability, numbers of days within which upgrades should be completed (e.g., a constraint may indicate that a rollout should be completed within the next 30 days), when a rollout should begin, and/or the like.

Once a schedule has been selected, the upgrade phases may be scheduled for the days and times indicated in the schedule, and customers may be notified of when their SDDC upgrades are scheduled. Subsequently, the upgrade phases may be initiated at the scheduled times on the various SDDCs in order to implement the rollout.

In some embodiments, upgrade phases may be dynamically rescheduled in response to detected outages. For example, if an outage at a given SDDC is detected, and there is an upgrade phase scheduled presently or within the next one or more hours (e.g., within a fixed window), then that upgrade phase may be automatically rescheduled to a maintenance window outside of the next one or more hours.

As regional outages occur, outage events may be published to schedule generator 230, or API methods may be invoked to indicate the outages. As schedule generator 230 receives the events or other indications of outages, it filters out the SDDCs which are located in outage regions when scheduling upgrade phases, and re-schedules any upgrade phases for these SDDCs that fall within the outage windows (e.g., fixed time intervals or time intervals indicated in the outage events or indications) to new times outside the outage windows.

FIG. 4 depicts an illustration 400 of an example related to data intelligence for automated resource-aware scheduling of software-defined data center (SDDC) upgrades. Illustration 400 includes schedule generator 230 of FIG. 2.

Data intelligence engine 410 generally provides predictive functionality based on historical data. For instance, data intelligence engine 410 may be one or more separate services from schedule generator 230 (e.g., in a SaaS layer), or may alternatively be part of schedule generator 230. Data intelligence engine 410 comprises one or more models 420 that are trained to perform predictive functionality.

For example, a first model 420 may be a machine learning model that is trained based on historical physical computing resource utilization data from particular SDDCs to predict future physical computing resource utilization. In certain embodiments, data intelligence engine 410 collects customers' SDDC one-year data of CPU usage (e.g., in megahertz) and amount of host physical memory consumed (e.g., in kilobytes), and in some embodiments data about migration of VCIs (e.g., vMotion), such as through calls to an application programming interface (API) of a resource monitoring service that provides resource utilization information for SDDCs. Data intelligence engine 410 may then attempt to fit yearly, weekly, and/or daily trends on an additive regression model to forecast the time-series data. On example of such an additive regression model is the open-source Prophet project, which may be used to train and forecast SDDC physical computing resource usage patterns. In an example, the forecasting problem is solved as a not accommodated by the model.

According to certain embodiments, a model 420 for predicting physical computing resource utilization may expose an API, which returns the future dates when utilization is predicted to be higher or lower as per customer usage patterns.

A second model 420 may be a machine learning model that is trained based on historical upgrade phase durations to predict durations of upgrade phases. For example, duration metrics indicating how long phases of historical upgrades took on particular SDDCs may be collected, along with parameters of the particular SDDCs such as SDDC identifiers, numbers of clusters, hosts, VMs or other VCIs, features, configuration settings, numbers of default and/or scale-out edge nodes, and/or the like. This collected data is then used to train a model 420, such as using supervised learning techniques, to predict a duration of an upgrade phase on a given SDDC based on parameters of the SDDC.

At 412, schedule generator 230 provides an SDDC identifier and date range to data intelligence engine 410, and data intelligence engine 410 returns resource utilization prediction data 414 for that SDDC and date range. For example, data intelligence engine 410 may provide one or more inputs to a model 420 based on the SDDC identifier and the date range, and the model 420 may output predicted physical computing resource utilization on the SDDC corresponding to the SDDC identifier for the date range, such as including predicted processing, memory, and/or networking resource utilization and/or predicted VCI migration activity. In some embodiments, resource utilization prediction data 414 includes days and/or times within the date range for which predicted physical computing resource utilization on the SDDC is above or below a threshold, and/or includes predicted physical computing resource utilization amounts for each hour and/or day.

Schedule generator 230 may use resource utilization prediction data 414 as part of its auto-placement algorithm, such as assigning upgrade phases to days and/or times for which physical computing resource utilization is predicted to be low. Thus, techniques described herein improve the functioning of computing devices through optimal utilization of available physical computing resources. Furthermore, by performing upgrade phases on days and/or time at which physical computing resource utilization is otherwise expected to be low, embodiments of the present disclosure minimize the impact to customer workloads by the upgrade process, particularly in the event of a failure during the upgrade process.

At 418, schedule generator 230 provides phase and/or SDDC attributes (e.g., an identifier and/or type of an upgrade and phase, and SDDC attributes as described above) to data intelligence engine 410, and data intelligence engine 410 returns phase duration prediction data 418. For example, data intelligence engine 410 may provide one or more inputs to a model 420 based on the phase and/or SDDC attributes, and the model 420 may output a predicted duration of the phase.

Schedule generator 230 may use phase duration prediction data 418 as part of its auto-placement algorithm, such as relying on predicted phase durations to determine the size of maintenance windows to which phases are to be assigned.

In other embodiments, durations of phases may be determined based on rules, such as defined in a document. For example, rules may be defined for particular upgrades indicating the durations of the phases. In one particular example, a rule for a given upgrade phase indicates that the first, second and third steps of the phase have durations of thirty minutes and the fourth step of the phase has a duration of forty minutes. The overall phase duration may be determined by adding the durations of the steps together. However, this rule-based approach to duration determination may not be particularly accurate, and it does not account for various parameters of an SDDC such as numbers of VMs, features enabled, configuration settings, and the like. As such, the data intelligence approach described above provides the ability to learn from past data and provide more accurate duration estimates for upgrade phases, thereby contributing to more seamless SDDC upgrades and better resource utilization due to more accurate scheduling. Furthermore, accurate upgrade phase durations determined according to embodiments of the present disclosure can be provided to the SDDCs that being upgraded, such as for display via a user interface to show an estimated completion time.

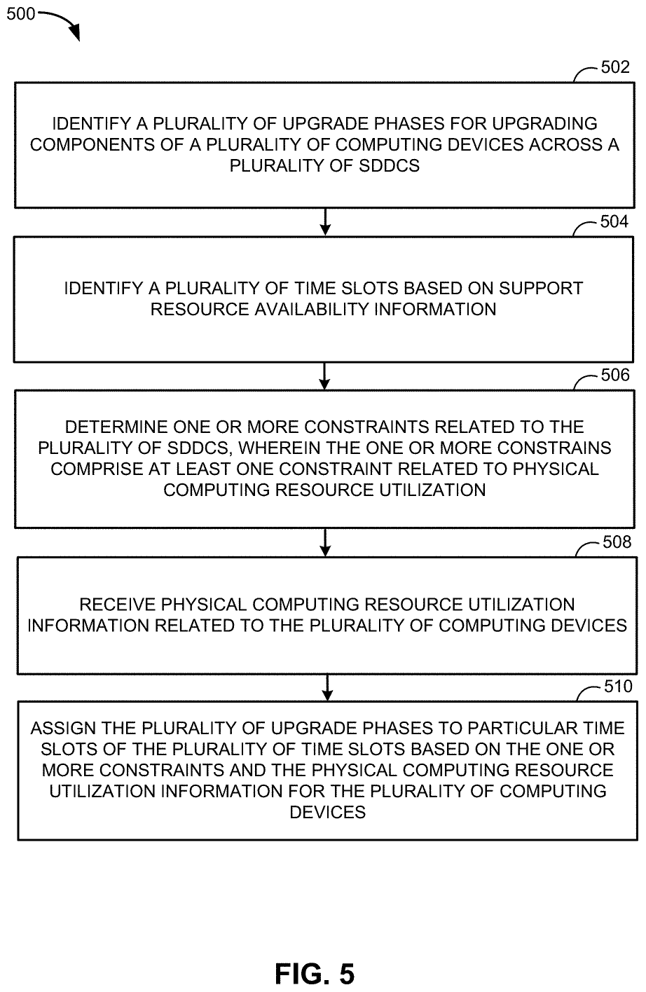

FIG. 5 depicts example operations 500 related to automated resource-aware scheduling of software-defined data center (SDDC) upgrades. For example, operations 500 may be performed by one or more components of upgrade manager 150 of FIG. 1.

Operations 500 begin at step 502, with identifying a plurality of upgrade phases for upgrading components of a plurality of computing devices across a plurality of SDDCs.

Operations 500 continue at step 504, with identifying a plurality of time slots based on support resource availability information.

Operations 500 continue at step 506, with determining one or more constraints related to the plurality of SDDCs, wherein the one or more constrains comprise at least one constraint related to physical computing resource utilization. In some embodiments, the one or more constraints are based on one or more customer preferences and/or one or more regional preferences.

Operations 500 continue at step 508, with receiving physical computing resource utilization information related to the plurality of computing devices.

Operations 500 continue at step 510, with assigning the plurality of upgrade phases to particular time slots of the plurality of time slots based on the one or more constraints and the physical computing resource utilization information for the plurality of computing devices.

Some embodiments further comprise predicting future physical computing resource utilization of the plurality of computing devices based on the physical computing resource utilization information. For example, assigning the plurality of upgrade phases to the particular time slots of the plurality of time slots may be based on the predicted future physical computing resource utilization.

Certain embodiments comprise determining upgrade capacities for the plurality of time slots based on the support resource utilization information, and assigning the plurality of upgrade phases to the particular time slots of the plurality of time slots may be based on the upgrade capacities.

Furthermore, some embodiments further comprise providing output via a user interface based on assigning the plurality of upgrade phases to the particular time slots. Certain embodiments comprise determining a score for the assigning of the plurality of upgrade phases to the particular time slots based on utilization of support resources associated with the plurality of time slots.

Some embodiments further comprise determining an outage related to a given SDDC of the plurality of SDDCs and re-assigning one or more upgrade phases associated with the given SDDC to one or more alternative time slots of the plurality of time slots based on the outage.

In some embodiments, durations of the plurality of upgrade phases are predicted based on historical upgrade duration data, and assigning the plurality of upgrade phases to the particular time slots of the plurality of time slots may be based on the predicted durations of the plurality of upgrade phases. For example, predicting the durations of the plurality of upgrade phases based on the historical upgrade duration data may comprise utilizing a machine learning model that has been trained based on the historical upgrade duration data.

The various embodiments described herein may employ various computer-implemented operations involving data stored in computer systems. For example, these operations may require physical manipulation of physical quantities—usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and/or the like.

One or more embodiments of the present invention may be implemented as one or more computer programs or as one or more computer program modules embodied in one or more computer readable media. The term computer readable medium refers to any data storage device that can store data which can thereafter be input to a computer system—computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)--CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system—level virtualization, wherein an abstraction layer is provided on top of the kernel of an operating system on a host computer. The abstraction layer supports multiple OS-less containers each including an application and its dependencies. Each OS-less container runs as an isolated process in userspace on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

We claim:

1. A method of resource-aware software-defined data center (SDDC) upgrades, comprising:
identifying a plurality of upgrade phases for upgrading components of a plurality of computing devices across a plurality of SDDCs;
identifying a plurality of time slots based on support resource availability information;
determining one or more constraints related to the plurality of SDDCs, wherein the one or more constrains comprise at least one constraint related to physical computing resource utilization;
receiving physical computing resource utilization information related to the plurality of computing devices; and
assigning the plurality of upgrade phases to particular time slots of the plurality of time slots based on the one or more constraints and the physical computing resource utilization information for the plurality of computing devices.

2. The method of claim 1, further comprising predicting future physical computing resource utilization of the plurality of computing devices based on the physical computing resource utilization information, wherein assigning the plurality of upgrade phases to the particular time slots of the plurality of time slots is based on the predicted future physical computing resource utilization.

3. The method of claim 2, wherein predicting the future physical computing resource utilization of the plurality of computing devices based on the physical computing resource utilization information comprises:
providing one or more inputs to a machine learning model based on the physical computing resource utilization information;
determining the future physical computing resource utilization of the plurality of computing devices based on one or more outputs from the machine learning model, wherein the machine learning model has been trained based on the historical physical computing resource utilization information.

4. The method of claim 1, wherein the one or more constraints are based on:
one or more customer preferences; or
one or more regional preferences.

5. The method of claim 1, further comprising determining upgrade capacities for the plurality of time slots based on the support resource availability information, wherein assigning the plurality of upgrade phases to the particular time slots of the plurality of time slots is based on the upgrade capacities.

6. The method of claim 1, further comprising providing output via a user interface based on assigning the plurality of upgrade phases to the particular time slots.

7. The method of claim 1, further comprising determining a score for the assigning of the plurality of upgrade phases to the particular time slots based on utilization of support resources associated with the plurality of time slots.

8. The method of claim 1, further comprising:
determining an outage related to a given SDDC of the plurality of SDDCs; and
re-assigning one or more upgrade phases associated with the given SDDC to one or more alternative time slots of the plurality of time slots based on the outage.

9. The method of claim 1, further comprising predicting durations of the plurality of upgrade phases based on historical upgrade duration data, wherein assigning the plurality of upgrade phases to the particular time slots of the plurality of time slots is based on the predicted durations of the plurality of upgrade phases.

10. The method of claim 9, wherein predicting the durations of the plurality of upgrade phases based on the historical upgrade duration data comprises utilizing a machine learning model that has been trained based on the historical upgrade duration data.

11. A system for resource-aware software-defined data center (SDDC) upgrades, the system comprising:
at least one memory; and
at least one processor coupled to the at least one memory, the at least one processor and the at least one memory configured to:
identify a plurality of upgrade phases for upgrading components of a plurality of computing devices across a plurality of SDDCs;
identify a plurality of time slots based on support resource availability information;
determine one or more constraints related to the plurality of SDDCs, wherein the one or more constrains comprise at least one constraint related to physical computing resource utilization;
receive physical computing resource utilization information related to the plurality of computing devices; and
assign the plurality of upgrade phases to particular time slots of the plurality of time slots based on the one or more constraints and the physical computing resource utilization information for the plurality of computing devices.

12. The system of claim 11, wherein the at least one processor and the at least one memory are further configured to predict future physical computing resource utilization of the plurality of computing devices based on the physical computing resource utilization information, wherein assigning the plurality of upgrade phases to the particular time slots of the plurality of time slots is based on the predicted future physical computing resource utilization.

13. The system of claim 12, wherein predicting the future physical computing resource utilization of the plurality of computing devices based on the physical computing resource utilization information comprises:
providing one or more inputs to a machine learning model based on the physical computing resource utilization information;
determining the future physical computing resource utilization of the plurality of computing devices based on one or more outputs from the machine learning model, wherein the machine learning model has been trained based on the historical physical computing resource utilization information.

14. The system of claim 11, wherein the one or more constraints are based on:
one or more customer preferences; or
one or more regional preferences.

15. The system of claim 11, wherein the at least one processor and the at least one memory are further configured to determine upgrade capacities for the plurality of time slots based on the support resource availability information, wherein assigning the plurality of upgrade phases to the particular time slots of the plurality of time slots is based on the upgrade capacities.

16. The system of claim 11, wherein the at least one processor and the at least one memory are further configured to provide output via a user interface based on assigning the plurality of upgrade phases to the particular time slots.

17. The system of claim 11, wherein the at least one processor and the at least one memory are further configured to determine a score for the assigning of the plurality of upgrade phases to the particular time slots based on utilization of support resources associated with the plurality of time slots.

18. The system of claim 11, wherein the at least one processor and the at least one memory are further configured to:
determine an outage related to a given SDDC of the plurality of SDDCs; and
re-assign one or more upgrade phases associated with the given SDDC to one or more alternative time slots of the plurality of time slots based on the outage.

19. The system of claim 11, wherein the at least one processor and the at least one memory are further configured to predict durations of the plurality of upgrade phases based on historical upgrade duration data, wherein assigning the plurality of upgrade phases to the particular time slots of the plurality of time slots is based on the predicted durations of the plurality of upgrade phases.

20. A non-transitory computer-readable medium storing instructions that, when executed by one or more processors, cause the one or more processors to:
identify a plurality of upgrade phases for upgrading components of a plurality of computing devices across a plurality of SDDCs;
identify a plurality of time slots based on support resource availability information;
determine one or more constraints related to the plurality of SDDCs, wherein the one or more constrains comprise at least one constraint related to physical computing resource utilization;
receive physical computing resource utilization information related to the plurality of computing devices; and
assign the plurality of upgrade phases to particular time slots of the plurality of time slots based on the one or more constraints and the physical computing resource utilization information for the plurality of computing devices.
